(19) United States
(12) Patent Application Publication
(10) Pub. No.: US 2013/0325712 A1
(43) Pub. Date: Dec. 5, 2013

(54) CARD PAYMENT SYSTEM INCLUDING MOBILE COMMUNICATION TERMINAL AND MOBILE RELAY DEVICE, APPARATUSES IN THE SYSTEM AND METHOD FOR CARD PAYMENT IN THE APPARATUSES

(71) Applicants: Kyung Yang Park, Seoul (KR); Hoon Joon Jung, Gunpo-si (KR); Hyo Jun Park, Seoul (KR)

(72) Inventors: Kyung Yang Park, Seoul (KR); Hoon Joon Jung, Gunpo-si (KR); Hyo Jun Park, Seoul (KR)

(73) Assignee: HAREX INFOTECH INC., Seoul (KR)

(21) Appl. No.: 13/985,969

(22) PCT Filed: Feb. 17, 2012
(86) PCT No.: PCT/KR2012/001222

§ 371 Date: Aug. 16, 2013

(30) Foreign Application Priority Data
Feb. 18, 2011 (KR) 10-2011-0014641

(51) Int. Cl. G06Q 20/34; G06Q 20/40

(52) U.S. Cl. CPC G06Q 20/34; G06Q 20/409
USPC 705/41

(57) ABSTRACT

Provided is a card payment system. The card payment system includes an affiliated merchant terminal configured to transmit payment-related information including an affiliated merchant ID and a payment amount and a relay device configured to store the payment-related information transmitted from the affiliated merchant terminal in a memory, and provide the payment-related information stored in the memory to a mobile communication terminal of a customer, for a card payment using the mobile communication terminal of the customer. Accordingly, a customer can safely and quickly perform a credit transaction by using a mobile communication terminal of the customer even without presenting a payment card to an affiliated merchant, and moreover perform the credit transaction at a desired place in the affiliated merchant even without unnecessarily moving to a counter or exposing financial information of the customer.

### TECHNICAL FIELD

The present disclosure relates to a card payment, and more particularly, to a card payment using a mobile communication terminal.

### BACKGROUND ART

In a related art card payment method in offline stores, an affiliated merchant terminal acquires a payment card identification number of a customer, and requests a payment approval from a financial company server via a VAN server by using affiliated merchant information and a payment amount. However, such a card payment method causes inconvenience to a customer because the customer should move to a counter and present a payment card to a clerk. To avoid such inconvenience, for example, a customer may present only a payment card to a clerk in its own seat and allow the clerk to pay, in restaurants and the like. However, such a method causes psychological anxiety to a customer because a clerk should move to a counter for card payment.

Moreover, in the related art card payment methods, financial information including a payment card identification number of a customer can be exposed to an affiliated merchant, a financial accident using card information of a customer can occur, and the risk of unauthorized user's duplicating payment card information increases. In addition, since payment card information of a customer is transmitted and received over a network in an approval process, there is the risk of hacking the payment card information of the customer in the approval process.

### DISCLOSURE

### Technical Problem

Therefore, an object of the present invention is to provide a technical method that enables a card payment to be performed even without customer's presenting card payment information of the customer requiring a security to an affiliated merchant or moving to a counter.

### Technical Solution

To achieve these and other advantages and in accordance with the purposes of the present invention as embodied and broadly described herein, a card payment system includes: an affiliated merchant terminal configured to transmit payment-related information including an affiliated merchant ID and a payment amount; and a relay device configured to store the payment-related information transmitted from the affiliated merchant terminal in a memory, and provide the payment-related information stored in the memory to a mobile communication terminal of a customer, for a card payment using the mobile communication terminal of the customer.

In another aspect, a relay device for a card payment using a mobile communication terminal includes: a communicator configured to transmit or receive data; a storage configured to store data; and a controller configured to transmit payment-related information to a mobile communication terminal of a customer through the communicator, for performing a card payment using the mobile communication terminal.

In another aspect, a mobile communication terminal for a card payment includes: a communicator configured to include one or more communication units for transmitting or receiving data; and a controller configured to transmit payment card information and payment-related information to an outside through the communicator for requesting an approval of a card payment, the payment-related information being acquired from a relay device.

In another aspect, a payment gateway for a card payment using a mobile communication terminal includes: a communicator configured to include one or more communication units for transmitting or receiving data; a database configured to store one or more pieces of payment card information of each member; and a controller configured to, when payment-related information including an affiliated merchant ID and a payment amount is received from a mobile communication terminal of a member through the communicator, search the database to check corresponding payment card information, and transmit the checked payment card information and the received payment-related information to a corresponding financial company server through the communicator to request an approval of a card payment.

In another aspect, a payment gateway for a card payment using a mobile communication terminal includes: a communicator configured to include one or more communication units for transmitting or receiving data; a database configured to store one or more pieces of payment card information of each member; and a controller configured to transmit the one or more pieces of payment card information stored in the database to a mobile communication terminal of a corresponding member through the communicator, and transmit one piece of payment card information received from the mobile communication terminal and payment-related information to a corresponding financial company server through the communicator to request an approval of a card payment, the payment-related information including an affiliated merchant ID and a payment amount.

In another aspect, a method of supporting a card payment using a mobile communication terminal in a relay device includes: receiving payment-related information, including an affiliated merchant ID and a payment amount, from an affiliated merchant terminal; storing the received payment-related information in a memory; displaying the payment-related information on a screen; and transmitting the payment-related information stored in the memory to a mobile communication terminal of a customer, for a card payment using the mobile communication terminal of the customer.

In another aspect, a method of supporting a card payment using a mobile communication terminal in a relay device includes: receiving a payment amount from a user; and transmitting payment-related information, including an affiliated merchant ID and the received payment amount, to a mobile communication terminal of a customer, for a card payment using the mobile communication terminal.

In another aspect, a card payment method of a mobile communication terminal includes: receiving payment-related information, including an affiliated merchant ID and a payment amount, from a relay device; displaying one or more pieces of payment card information of a user of a mobile communication terminal; and transmitting one piece of payment card information, selected by the user from among the displayed one or more pieces of payment card information, and the payment-related information to a payment gateway, for requesting an approval of a card payment.

In another aspect, a method of supporting a card payment using a mobile communication terminal in a payment gateway includes: receiving payment-related information, including an affiliated merchant ID and a payment amount, from a mobile communication terminal of a member which desires a card payment; when the payment-related information is received, searching a database to find payment card information of the member; and transmitting the received payment-related information and the found payment card information to a corresponding financial company server to request an approval of a card payment.

In another aspect, a method of supporting a card payment using a mobile communication terminal in a payment gateway includes: searching a database to find payment card information of a member which desires a card payment; transmitting one or more pieces of the found payment card information to a mobile communication terminal of the member; receiving payment card information, selected by the member from among the one or more pieces of payment card information, and payment-related information from the mobile communication terminal, the payment-related information including an affiliated merchant ID and a payment amount; and transmitting the received payment card information and payment-related information to a corresponding financial company server.

### Advantageous Effects

The present invention enables a customer to safely and quickly perform a credit transaction by using a mobile communication terminal of the customer even without customer's presenting a payment card to an affiliated merchant, and moreover enables the customer to perform the credit transaction at a desired place in the affiliated merchant even without unnecessarily moving to a counter or exposing financial information of the customer.

Moreover, according to the present invention, payment card information (an identification number, a valid date, etc.) specially requiring a security is not exposed to a network, and thus, a stability of a credit transaction is certainly ensured.

### DESCRIPTION OF DRAWINGS

FIG. 1 is a diagram illustrating a configuration of a card payment system according to an embodiment of the present invention.

FIG. 2 is a block diagram illustrating a relay device according to an embodiment of the present invention.

FIG. 3 is a block diagram illustrating a mobile communication terminal according to an embodiment of the present invention.

FIG. 4 is a block diagram illustrating a payment gateway according to an embodiment of the present invention.

FIG. 5 is a flowchart illustrating a card payment performed between an affiliated merchant terminal, the relay device, and the mobile communication terminal according to an embodiment of the present invention.

FIG. 6 is a flowchart for a card payment performed between the mobile communication terminal, the payment gateway, and a financial company server according to an embodiment of the present invention.

FIG. 7 is a flowchart for a card payment performed between the mobile communication terminal, the payment gateway, and the financial company server according to another embodiment of the present invention.

FIG. 8 is a flowchart for a card payment performed between the mobile communication terminal, the payment gateway, and the financial company server according to another embodiment of the present invention.

### BEST MODE

Further aspects of the present invention described above will be clarified through the following embodiments described with reference to the accompanying drawings. Hereinafter, embodiments of the present invention will be described in detail in order for those skilled in the art to easily understand and reproduce the present invention through the embodiments.

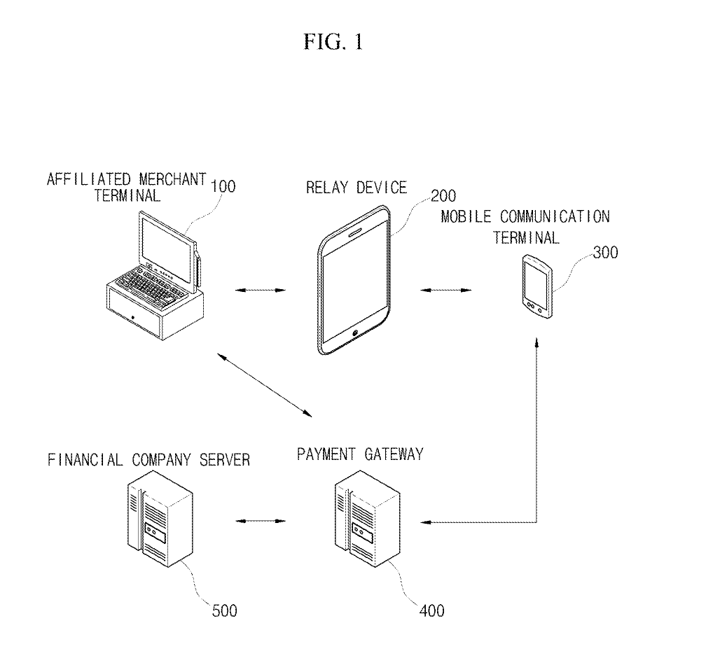

FIG. 1 is a diagram illustrating an entire configuration of a card payment system according to an embodiment of the present invention.

Referring to FIG. 1, the card payment system includes an affiliated merchant terminal 100, a relay device 200, a mobile communication terminal 300, a payment gateway 400, and a financial company server 500. A system including only some of the elements is also referred to as the card payment system. The affiliated merchant terminal 100 may be a CAT terminal or a POS terminal. An internal memory of the affiliated merchant terminal 100 stores an affiliated merchant identifier (ID). Also, the affiliated merchant terminal 100 includes number key buttons for inputting a payment amount of a product purchased or a service used by a customer. The number key buttons may be configured in hardware, or may be configured in software and provided through a touch screen. The affiliated merchant terminal 100 includes a means for contact or non-contact communication with the below-described relay device 200. Also, the affiliated merchant terminal 100 includes a communication module for wired or wireless communication with the outside, or includes a dongle access means for wired or wireless communication. The dongle access means may be an USB port, and a dongle may be a near field communication (NFC) reader. Further, a wireless communication module for the affiliated merchant terminal 100 may be, for example, an NFC module, an RF communication module, a Bluetooth module, a Wi-Fi communication module, or a Zigbee communication module. In addition, the wired communication may be, for example, USB communication or serial communication.

The affiliated merchant terminal 100 transmits payment-related information including the affiliated merchant ID and a payment amount through contact, wired, or wireless (non-contact) communication. Also, the affiliated merchant terminal 100 may be communication-connected to the payment gateway 400 over a wired telephone network, the Internet network, or a wireless communication network. The affiliated merchant terminal 100 may receive an approval number (card payment approval information) from the payment gateway 400 over a specific network such as the networks, and generate and print sales-check data including payment-related information and an approval number. Alternatively, the affiliated merchant terminal 100 may transmit the approval number, received from the payment gateway 400, to the relay device 200 in order for the relay device 200 to print the sales check.

The relay device 200 may be a device that enables an external reader to read data stored in an internal memory chip of the relay device 200. Alternatively, the relay device 200 may be a small-size device able to perform contact, wired, or wireless (non-contact) communication. When the relay device 200 is a portable device, the relay device 200 may support at least one of contact, wired, and wireless (non-contact) communications. Otherwise, the relay device 200 may be a device that is fixed and attached to a customer table in an affiliated merchant such as a restaurant, in which case the relay device 200 may include one or more wireless communication modules. Additionally, when the relay device 200 is the device that is fixed and attached to the customer table, the relay device 200 may have a charging function for the mobile communication terminal 300, for a customer's convenience. The relay device 200 may be manufactured in a card type. When the relay device 200 has the card type, the relay device 200 may be a plastic card, to which a combi-chip or an NFC chip enabling short-distance communication is attached, or a chip itself. The card type relay device 200 may be implemented in a type integrated with a billboard that is a bill holder, or implemented to be attachable/detachable to/from the billboard. In the latter, when the billboard has a folding type, a groove into which a card is inserted may be provided in the billboard. Further, a card logo may be marked on an outer surface of the billboard, or a display unit may be provided at the outer surface of the billboard. For another example, the relay device 200 may be implemented as a pad or a tap personal computer (PC) that includes a display unit and performs wireless communication. The relay device 200 may include one or more wireless communication modules, and communicates with the affiliated merchant terminal 100 and the mobile communication terminal 300 of a customer by using the wireless communication module.

The relay device 200 receives payment-related information including the affiliated merchant ID and a payment amount from the affiliated merchant terminal 100, and provides the payment-related information to the mobile communication terminal 300 of a customer. On the other hand, the relay device 200 may receive the affiliated merchant ID and the payment amount from a user without receiving the affiliated merchant ID and the payment amount from the affiliated merchant terminal 100. Also, an affiliated merchant ID may be previously stored in a memory, in which case it is not required for a user to input the affiliated merchant ID. Further, the relay device 200 includes a printing means. In this case, the relay device 200 receives an approval number from the affiliated merchant terminal 100, the mobile communication terminal 300, the payment gateway 400, or the financial company server 500, generates sales-check data including payment-related information and the approval number, and prints the sales check through the printing means.

The mobile communication terminal 300 denotes a terminal of a customer of an affiliated merchant, and may be a feature phone, a smartphone, or a PDA terminal. The mobile communication terminal 300 includes a wireless communication module for communication, and preferably, short-distance wireless communication with the relay device 200, and includes a wireless communication module for long-distance wireless communication with the payment gateway 400. The kind of wireless communication module is not limited. The mobile communication terminal 300 executes a payment program for a card payment to perform a payment process. The mobile communication terminal 300 receives payment-related information necessary to perform the payment process from the relay device 200, and transmits the payment-related information to the payment gateway 400 over a specific network to request a card payment approval. In an embodiment, the mobile communication terminal 300 transmits payment-related information, which is received from the relay device 200 for requesting a card payment approval, to the payment gateway 400 without transmitting payment card information. In another embodiment, the mobile communication terminal 300 all payment card information and payment-related information to the payment gateway 400, for requesting a card payment approval. Here, the payment card information may be information including an identification number (a payment card number composed of sixteen numbers), or may be information for determining the kind of payment card, and for example, may be a payment card name or a unique ID given to a payment card.

The payment gateway 400 is communication-connected to the mobile communication terminal 300 over a specific network such as a mobile communication network, and communication-connected to the financial company server 500 over a dedicated packet network or the like. The payment gateway 400 provides a payment service using the mobile communication terminal 300. To provide the payment service, the payment gateway 400 uses a database in which information on payment service members is registered, and performs the payment process in interoperation with the mobile communication terminal 300 executing the payment program. In an embodiment, the payment gateway 400 receives payment-related information from the mobile communication terminal 300 over a specific network, extracts payment card information of a corresponding member stored in the database, and transmits the payment-related information and the payment card information to the financial company server 500 to request a card payment approval. In another embodiment, the payment gateway 400 receives the payment-related information and the payment card information from the mobile communication terminal 300 over the specific network, and transmits the payment-related information and the payment card information to the financial company server 500 to request a card payment approval. When an approval number for the card payment is received from the financial company server 500 in response to the card payment approval request according to the embodiments, the payment gateway 400 transmits the received approval number to the mobile communication terminal 300. Also, the payment gateway 400 may transmit the approval number to the affiliated merchant terminal 100. Alternatively, the payment gateway 400 may directly transmit the approval number to the relay device 200.

The financial company server 500 denotes a credit card company server or a bank server for a card payment approval. The financial company server 500 determines whether to approve the card payment approval request, by using a database that stores information on a registered payment card for each member. The database may store information on a unique ID given to each payment card. Further, the database stores a personal identification number (PIN) set by an owner of each payment card. The financial company server 500 receives payment card information and payment-related information from the payment gateway 400, and performs a processing of a card transaction approval with reference to the database. When the card transaction is determined as being normal, the financial company server 500 generates an approval number that is card payment approval information, and transmits the approval number to the payment gateway 400, thereby performing a series of payment process. On the other hand, the financial company server 500 receives the payment card information and the payment-related information from the mobile communication terminal 300, and performs the processing of the card transaction approval with reference to the database. When the card transaction is determined as being normal, the financial company server 500 generates the approval number, and transmits the approval number to the mobile communication terminal 300, thereby performing a series of payment process.

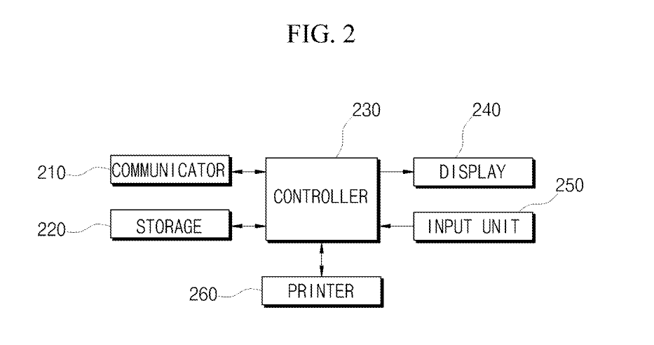

FIG. 2 is a block diagram illustrating the relay device according to an embodiment of the present invention.

Referring to FIG. 2, the relay device 200 includes a communicator 210, a storage 220, and a controller 230. The communicator 210 includes one or more communication means. The communicator 210 supports at least one of contact, wired, and wireless (non-contact) communication schemes. In the wireless communication scheme, the communicator 210 may include one or more of wireless communication modules such as the NFC module, the RF communication module, the Bluetooth module, the Wi-Fi communication module, and the Zigbee communication module. The storage 220 is a memory for storing data, and may be configured with at least one or more of a read-only memory (ROM), a random access memory (RAM), an electrically erasable and programmable read-only memory (EEPROM), and a flash memory (FM). Alternatively, the storage 220 may be a buffer memory for temporarily storing data. The controller 230 may be a control means that is configured with a central processing unit (CPU), and overall controls an apparatus.

The relay device 200 receives payment-related information from the affiliated merchant terminal 100 through the communicator 210. The payment-related information includes information on at least the affiliated merchant ID and a payment amount. Further, the payment-related information may further include information on a purchase product, food, or a service item requiring a payment. The communicator 210 outputs the received payment-related information to the controller 230. The controller 230 stores the payment-related information in the storage 220. Subsequently, when the relay device 220 is wirelessly communication-connected to the mobile communication terminal 300 of a customer, the controller 230 reads the payment-related information stored in the storage 220, and transmits the payment-related information to the mobile communication terminal 300 through the communicator 210.

In an embodiment, when the relay device 200 is connected to the affiliated merchant terminal 100 in a contact communication scheme or it is searched that the relay device 200 is within a short-distance communication range, the affiliated merchant terminal 100 transmits payment-related information to the searched relay device 200. In another embodiment, the affiliated merchant terminal 100 transmits the payment-related information to the relay device 200 designated by a key input of a clerk. In another embodiment, the controller 230 of the relay device 200 requests the payment-related information from the affiliated merchant terminal 100 through the communicator 210, and the affiliated merchant terminal 100 transmits the payment-related information to the relay device 200 in response to the request. At this time, in order for the affiliated merchant terminal 100 to identify the relay device 200, the controller 230 of the relay device 200 may transmit both a unique ID given to the relay device 200 and the payment-related information to the affiliated merchant terminal 100 through the communicator 210. Therefore, the affiliated merchant terminal 100 identifies the relay device 200, checks payment-related information required to be transmitted to the relay device 200, and transmits the checked payment-related information to the relay device 200. In another embodiment, the relay device 200 is considered to be attached to a customer table. That is, when the relay device 200 attached to the customer table requests payment-related information, the affiliated merchant terminal 100 transmits the payment-related information on a corresponding customer to the relay device 200.

In addition, the relay device 200 further includes a display 240. The display 240 may be a liquid crystal display (LCD). The controller 230 outputs the payment-related information, stored in the storage 220 or received through the communicator 210, to the display 240. This is for enabling a customer to check the payment-related information. For example, items of the payment-related information displayed by the display 240 may include an affiliated merchant name, a purchase product name, a payment amount, etc.

Moreover, the relay device 200 further includes an input unit 250. The input unit 250 is an interface for a user input. The input unit 250 may be a key button that is configured in hardware or a key button that is configured in software and displayed by the display 240, or may include both thereof. When the input unit 250 is the key button that is configured in software and displayed by the display 240, the display unit 240 and the input unit 250 are implemented as a single user input/output interface called a touch screen. The controller 230 may output payment-related information to the display 240 according to a user key input received through the input unit 250. Also, the controller 230 transmits the payment-related information, stored in the storage 220, to the mobile communication terminal 300 through the communicator 200 according to the user key input received through the input unit 250. That is, only when there is a specific key input from the user, the controller 230 transmits the payment-related information to the mobile communication terminal 300 communication-connected thereto. For example, a clerk or a customer directly manipulates the relay device 200 to select a payment using the mobile communication terminal 300, and thus, the controller 230 transmits the payment-related information, stored in the storage 220, to the mobile communication terminal 300 through the communicator 200.

The relay device 200, as described above, may directly receive payment-related information from a user without receiving the payment-related information from the affiliated merchant terminal 100. That is, the relay device 200 may receive an affiliated merchant ID and a payment amount through the input unit 250. Here, the affiliated merchant ID may not be inputted through the input unit 250 but may be stored in the storage 200.

Moreover, the relay device 200 further includes a printer 260. The printer 260 is an element for printing a sales check. When an approval number is received through the communicator 210 from the affiliated merchant terminal 100, the mobile communication terminal 300, the payment gateway 400, or the financial company server 500, the controller 230 outputs the approval number to the display 240 so as to enable a customer to know the approval number, and moreover generates sales-check data including payment-related information and the approval number. The controller 230 receives a signature through the touch screen from the customer, and generates sales-check data with the signature added thereto. The controller 230 outputs the generated sales-check data to the printer 260, which prints the sales check.

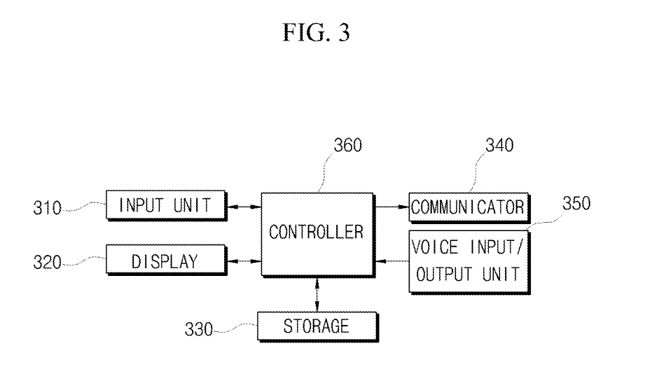

FIG. 3 is a block diagram illustrating the mobile communication terminal according to an embodiment of the present invention.

Referring to FIG. 3, an input unit 310 and a display 320 may be generally-known elements. The input unit 310 and the display 320 may be implemented as a single user interface such as the touch screen. A storage 330 may include the ROM, the RAM, the EEPROM, the flash memory, etc. The storage 330 stores control program data for controlling an overall operation of the mobile communication terminal 300. Also, the storage 330 may store a payment program for a card payment. Alternatively, the payment program may be stored in a universal subscriber identity module (USIM) chip mounted on the mobile communication terminal 300. Alternatively, the payment program may be stored in an external memory card attachable/detachable to/from the mobile communication terminal 300. In the following description, the USIM chip and the external memory card may be construed as being included in the storage 330.

A communicator 340 includes one or more communication means. The communicator 340 may include at least one or more of the wireless communication modules such as the NFC module, the RF communication module, the Bluetooth module, the Wi-Fi communication module, and the Zigbee communication module, and include a wireless communication module for mobile communication or Internet communication using TCP/IP. A voice input/output unit 350 is a known element that converts digital voice data into an analog voice signal or performs an inverse conversion thereof, and includes an additional circuit such as an audio amplification circuit or a filter. A controller 360 may include dedicated hardware for processing communication, a digital signal processor, and a general-purpose microprocessor. Elements configuring the controller 360 may be configured with dedicated hardware or software or a combination thereof.

The controller 360 executes the payment program stored in the storage 330 to perform a payment process. By executing the payment program, the mobile communication terminal 300 interoperates with the payment gateway 400. To provide a description on the payment process, first, the controller 360 receives payment-related information from the relay device 200 through the communicator 340. The controller 360 may output the received payment-related information to the display 320, thereby enabling a user to check the payment-related information. In an embodiment, the controller 360 transmits only the payment-related information to the payment gateway 400 through the communicator 340. In another embodiment, the controller 360 transmits payment card information and the payment-related information to the payment gateway 400 through the communicator 340. Here, the payment card information may be information including a payment card identification number, information on a payment card name, or information on a unique ID given to a payment card. In the following description on embodiments, a case in which payment card information is stored in the storage 330 and a case in which the payment card information is not stored in the storage 330 will be described separately.

### Embodiment 1

Payment card information may be stored in the storage 330. The payment card information stored in the storage 330 is one or more pieces of payment card information. Therefore, a card for a payment should be selected. For example, when only one piece of payment card information is stored in the storage 330, a card selection procedure may not be performed. Also, despite two or more pieces of payment card information being stored in the storage 330, even when one card is set as a primary card, the card selection procedure may not be performed. The primary card may be set according to a user input received through the input unit 310, and may be changed. When the card selection procedure is required, information of each payment card stored in the storage 330 may include information of a payment card name. Further, the information of each payment card may further include information of a payment card identification number, or may further include information of a unique ID given to each payment card, instead of the payment card identification number. The unique ID itself cannot be personal financial information, and thus, even though the unique ID is exposed to an unauthorized user, financial assets of a card owner run into danger.

The controller 360 outputs a payment card list, listing payment card names among the payment card information stored in the storage 330, to the display 320, and enables a user to select a desired payment card. Also, the controller 360 may require an input of an authentication code of the selected payment card. The authentication code is a PIN, and is used for the payment gateway 400 or the financial company server to authenticate whether the authentication code is a registered personal identification number of each payment card. When the user selects one payment card through the input unit 310, the controller 360 reads a card identification number corresponding to the selected payment card or a unique ID given to the payment card, and transmits the card identification number to the payment gateway 400 through the communicator 340. Also, the controller 360 transmits a PIN, inputted through the input unit 310, to the payment gateway 400 through the communicator 340. Also, the controller 360 transmits payment-related information, received from the relay device 200, to the payment gateway 400 through the communicator 340. The payment card information, the PIN, and the payment-related information may be each transmitted, and at least some thereof may be transmitted together. Subsequently, the controller 360 receives an approval number (payment approval information) from the payment gateway 400 through the communicator 340, and outputs the approval number to the display 320, thereby informing a normally approved result of the user. Further, the controller 360 may transmit the approval number to the relay device 200 through the communicator 340. This is for allowing the relay device 200 to use the approval number in printing a sales check.

### Embodiment 2

Payment card information may not be stored in the storage 330. In an embodiment, the controller 360 transmits only payment-related information to the payment gateway 400 through the communicator 340. In another embodiment, the controller 360 requests payment card information from the payment gateway 400 through the communicator 340, and receives the payment card information from the payment gateway 400 through the communicator 340. Here, the payment card information may not be requested. That is, when the mobile communication terminal 300 executes the payment program to interoperate with the payment gateway 400, the payment gateway 400 may transmit the payment card information to the mobile communication terminal 300 even without a request of the mobile communication terminal 300. In addition, the payment card information transferred from the payment gateway 400 to the mobile communication terminal 300 is a payment card list, and may further include a unique ID given to each payment card.

The controller 360 outputs the payment card list (the received payment card information) to the display 320, and allows a user to select a desired payment card. Also, the controller 360 may request an input of a PIN of the selected payment card. When the user selects one payment card through the input unit 310, the controller 360 transmits the selected payment card name or a unique ID given to the payment card to the payment gateway 400 through the communicator 340. Also, the controller 360 transmits a PIN, inputted through the input unit 310, to the payment gateway 400 through the communicator 340. Also, the controller 360 transmits payment-related information, received from the relay device 200, to the payment gateway 400 through the communicator 340. The payment card information, the PIN, and the payment-related information may be each transmitted, and at least some thereof may be transmitted together. Subsequently, the controller 360 receives an approval number from the payment gateway 400 through the communicator 340, and outputs the approval number to the display 320, thereby informing a normally approved result of the user. Further, the controller 360 may transmit the approval number to the relay device 200 through the communicator 340. This is for allowing the relay device 200 to use the approval number in printing a sales check.

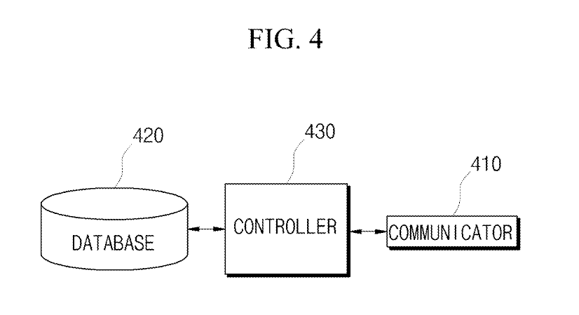

FIG. 4 is a block diagram illustrating the payment gateway according to an embodiment of the present invention.

Referring to FIG. 4, the payment gateway 400 includes a communicator 410, a database 420, and a controller 430. The communicator 410 includes two or more communication means. The communicator 410 includes a communication element for communicating with the mobile communication terminal 300 over a specific network and a communication element for communicating with the financial company server 500 over a dedicated packet network. The communication elements may be the same, in which case the communication elements are not required to be doubly provided. Information on members, desiring to use a payment service using a mobile communication terminal, is registered in the database 420. For example, the database 420 stores a member name, a phone number of a mobile communication terminal, and information of a payment card of each member. Here, the information of the payment card of each member includes financial company information and at least one of a payment card name, a payment card identification number, and a unique ID given to each payment card, for each payment card. Further, the database 420 may further store PIN information of each payment card. The controller 430 is a processor for executing a payment process. Hereinafter, embodiments of the payment process of the controller 430 will be described separately.

### Embodiment 3

The payment gateway 400 receives payment-related information from the mobile communication terminal 300, but does not receive payment card information. In this case, the payment card of each member stored in the database 420 includes the financial company information and information on the payment card identification number or the unique ID given to each payment card. In addition, when a member has two or more payment cards, one of the payment cards may be set as a primary card for performing a real payment. The primary card may be previously set by the member.

The controller 430 receives the payment-related information from the mobile communication terminal 300 through the communicator 410. When the payment-related information is received, the controller 430 searches the database 420 to check payment card information of a corresponding member. When the payment card information of the corresponding member is checked, the controller 430 transmits the received payment-related information and payment card information (a payment card identification number or a unique ID given to a payment card) to a corresponding financial company server 500 through the communicator 410. Subsequently, when an approval number is received from the financial company server 500 through the communicator 410, the controller 430 transmits the received approval number to the mobile communication terminal 300 through the communicator 410. Also, the controller 430 transmits the received approval number to the affiliated merchant terminal 100 through the communicator 410.

### Embodiment 4

The payment gateway 400 receives all payment card information and payment-related information from the mobile communication terminal 300. This case is divided into a case, in which the payment gateway 400 provides a payment card list (the payment card information) to the mobile communication terminal 300, and a case in which the payment gateway 400 does not provide the payment card list. In the embodiment 4, a case in which the payment gateway 400 does not provide the payment card list to the mobile communication terminal 300 will be described. In an embodiment 5, a case in which the payment gateway 400 provides the payment card list to the mobile communication terminal 300 will be described.

The controller 430 receives the payment card information and the payment-related information from the mobile communication terminal 300 through the communicator 410. The information may be each received, or may be received together. The received payment card information may be a payment card name, or may be a unique ID given to a corresponding payment card. When the received payment card information is the payment card name, the controller 430 searches the database 420 to check a corresponding unique ID, reads the checked unique ID, and transmits both the payment-related information and the unique ID to a corresponding financial company server 500 through the communicator 410. When the received payment card information is the unique ID, the controller 430 transmits both the received payment card information and payment-related information to the financial company server 500 through the communicator 410.

The controller 430 may further receive a PIN from the mobile communication terminal 300 through the communicator 410. In an embodiment, the controller 430 searches the database to authenticate the PIN, and only when the authentication succeeds, the controller 430 transmits the payment card information and the payment-related information to the financial company server 500 through the communicator 410. In another embodiment, in order for the financial company server 500 to authenticate the PIN, the controller 430 transmits the payment card information and the payment-related information to the financial company server 500 through the communicator 410 without authenticating the PIN. Subsequently, when an approval number is received from the financial company server 500 through the communicator 410, the controller 430 transmits the received approval number to the mobile communication terminal 300 through the communicator 410. Also, the controller 430 transmits the received approval number to the affiliated merchant terminal 100 through the communicator 410.

### Embodiment 5

When the mobile communication terminal 300 requests payment card information, the controller 430 reads payment card information of a corresponding member from the database 420, and transmits the read payment card information to the mobile communication terminal 300 through the communicator 410. Alternatively, when the controller 430 interoperates with the mobile communication terminal 300 for a payment process, the controller 430 may the payment card information to the mobile communication terminal 300 even without the mobile communication terminal 300 requesting the payment card information. The payment card information transmitted to the mobile communication terminal 300 includes a list of payment card names, and may further include a unique ID given to a corresponding payment card. However, the payment card information does not include a payment card identification number. Subsequently, the controller 430 receives the payment card information and the payment-related information from the mobile communication terminal 300 through the communicator 410. The information may be each received, or may be received together. The received payment card information may be a payment card name, or may be the unique ID given to the corresponding payment card. When the received payment card information is the payment card name, the controller 430 searches the database 420 to check the unique ID, reads the checked unique ID, and transmits both the payment-related information and the unique ID to a corresponding financial company server 500 through the communicator 410. When the received payment card information is the unique ID, the controller 430 transmits both the received payment card information and payment-related information to the financial company server 500 through the communicator 410.

The controller 430 may further receive a PIN from the mobile communication terminal 300 through the communicator 410. In an embodiment, the controller 430 searches the database to authenticate the PIN, and only when the authentication succeeds, the controller 430 transmits the payment card information and the payment-related information to the financial company server 500 through the communicator 410. In another embodiment, in order for the financial company server 500 to authenticate the PIN, the controller 430 transmits the payment card information and the payment-related information to the financial company server 500 through the communicator 410 without authenticating the PIN. Subsequently, when an approval number is received from the financial company server 500 through the communicator 410, the controller 430 transmits the received approval number to the mobile communication terminal 300 through the communicator 410. Also, the controller 430 transmits the received approval number to the affiliated merchant terminal 100 through the communicator 410.

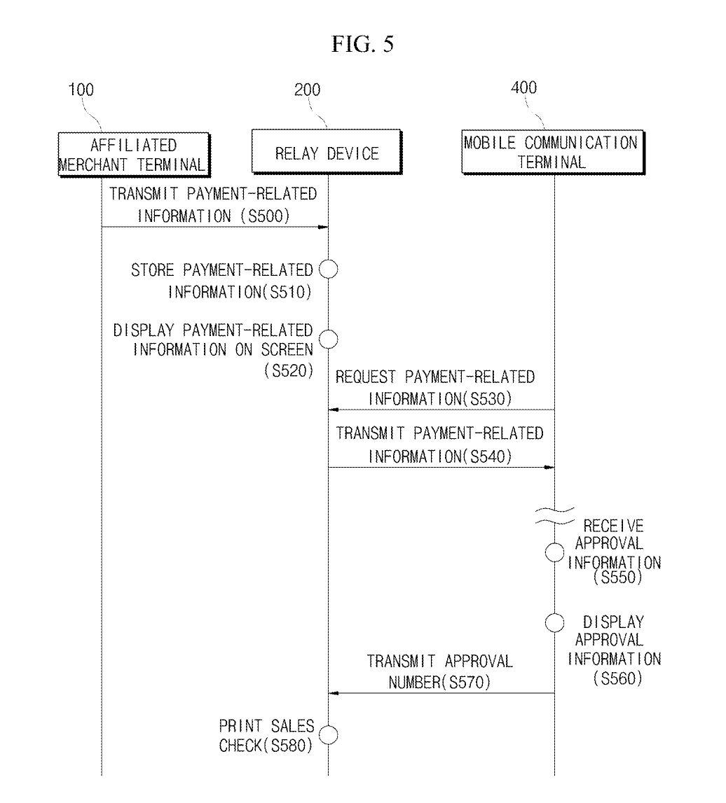

FIG. 5 is a flowchart illustrating a card payment performed between the affiliated merchant terminal, the relay device, and the mobile communication terminal according to an embodiment of the present invention.

A clerk manipulates the affiliated merchant terminal 100 to input a payment amount of a customer. The affiliated merchant terminal 100 transmits an affiliated merchant ID stored in the internal memory and payment-related information including the input payment amount to the relay device 200 in operation S500. In an embodiment, when the relay device 200 is portable, the affiliated merchant terminal 100 transmits the payment-related information to the relay device 200 (which is searched through wireless communication) in contact-connection with the relay device 200 or in a short-distance area. In another embodiment, when the relay device 200 is attached to a customer table, the affiliated merchant terminal 100 transmits the payment-related information to the relay device 200 which is designated according to the key input manipulation of the clerk. In another embodiment, when the relay device 200 requests the payment-related information, the affiliated merchant terminal 100 searches for the requested payment-related information to transmit the payment-related information to the relay device 200. Here, the relay device 200 may request the payment-related information according to a command of a customer or the clerk. That is, the relay device 200 requests the payment-related information according to a key input received through the input unit 250 included in the relay device 200 of the customer or the clerk.

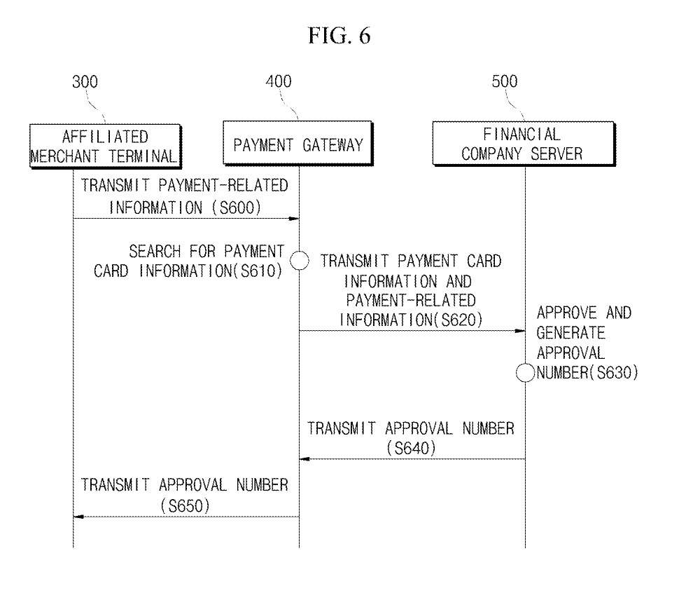

The relay device 200 receives the payment-related information from the affiliated merchant terminal 100. The relay device 200 stores the received payment-related information in a memory in operation 5510, and displays the payment-related information on a screen so as to check the payment-related information in operation 5520. Here, the memory may be a buffer memory for temporarily storing the payment-related information. The customer checks the payment-related information displayed on the screen of the relay device 200, and when the payment amount is right, the customer manipulates its own mobile communication terminal 300 to issue a command to execute the payment program. The mobile communication terminal 300 executes the payment program stored in a memory. When the payment program is being executed, the mobile communication terminal 300 requests the payment-related information from the relay device 200 in operation 5530. However, the request operation may not be performed. The relay device 200 transmits the payment-related information to the mobile communication terminal 300 according to the payment-related information request of the mobile communication terminal 300 or even without the request in operation 5540. On the other hand, only when a payment scheme using the mobile communication terminal 300 is selected, the relay device 200 may transmit the payment-related information to the mobile communication terminal 300. The mobile communication terminal 300 receives the payment-related information transmitted from the relay device 200. A procedure of FIGS. 6 to 8 is performed, and then the mobile communication terminal 300 receives an approval number (card payment approval information) from the payment gateway 400 in operation 5550. The mobile communication terminal 300 displays the approval number on a screen so as to check the approval number in operation S560.

Further, the mobile communication terminal 300 transmits the approval number to the relay device 200 in operation S570. Alternatively, unlike the illustrated, the affiliated merchant terminal 100 may transmit the approval number, received from the payment gateway 400, to the relay device 200 without the mobile communication terminal 300 performing operation S570. The relay device 200 receives the approval number from the mobile communication terminal 300 or the affiliated merchant terminal 100. When the approval number is received, the relay device 200 generates sales-check data including the payment-related information and the approval number, and prints a sales check with the generated sales-check data reflected therein in operation S580.

In the above-described operation, the relay device 200 may not receive the payment-related information from the affiliated merchant terminal 100 but may receive the payment-related information from a user. That is, the user may input an affiliated merchant ID and a payment amount through the input unit 250. Alternatively, the user may input only the payment amount. When the user inputs only the payment amount, this is a case in which the affiliated merchant ID is stored in the memory of the relay device 200. That is, the relay device 200 may not acquire the payment-related information from the affiliated merchant terminal 100.

FIG. 6 is a flowchart for a card payment performed between the mobile communication terminal, the payment gateway, and a financial company server according to an embodiment of the present invention.

The mobile communication terminal 300 transmits payment-related information to the payment gateway 400 in operation S600. The payment gateway 400 receives the payment-related information from the mobile communication terminal 300, and searches for payment card information of a corresponding member registered in the database in operation S610. When information on two or more payment cards of a corresponding member is registered, one piece of predetermined payment card information is searched as payment card information for a real payment. The payment gateway 400 transmits the payment card information searched from the database and the payment-related information (received from the mobile communication terminal 300) to a corresponding financial company server 500 in operation S620. Here, the payment card information transmitted from the financial company server 500 may be information, including a payment cart identification number, or a unique ID given to the payment card. When the payment card information is the unique ID, as described above, the payment card information itself cannot be personal financial information, and thus, even when the payment card information is hacked over a network, financial assets of a corresponding member cannot be in danger.

The financial company server 500 receives the payment card information and the payment-related information from the payment gateway 400. The financial company server 500 determines whether to approve according to a card payment approval request, by using a database that stores registered payment card information of each card member. Specifically, the financial company server 500 compares the received payment card information and payment-related information with member data or affiliated merchant data of each company to determine whether a transaction between a payment card user and an affiliated merchant is right. At this time, even when the received payment card information includes only information on a unique ID given to a corresponding payment card without including a payment card identification number, the financial company server 500 may validly approve the card transaction because unique ID information of each payment card is previously registered in the database. When the transaction between the payment card user and the affiliated merchant is right, the financial company server 500 generates an approval number for approving the transaction in operation S630, and transmits the generated approval number to the payment gateway 400 in operation S640. The payment gateway 400 receives the approval number from the financial company server 500, and transmits the received approval number to the mobile communication terminal 300 in operation S650. Also, the payment gateway 400 may transmit the approval number to the affiliated merchant terminal 100. Also, the payment gateway 400 may directly transmit the approval number to the relay device 200. To this end, the payment gateway 400 should know an Internet protocol (IP) address of the relay device 200 for transmitting the approval number to the relay device 200. That is, the relay device 200 transmits the IP address and payment-related information to the mobile communication terminal 300, and the mobile communication terminal 300 transfers the IP address to the payment gateway 400, thereby enabling the payment gateway 400 to know the IP address.

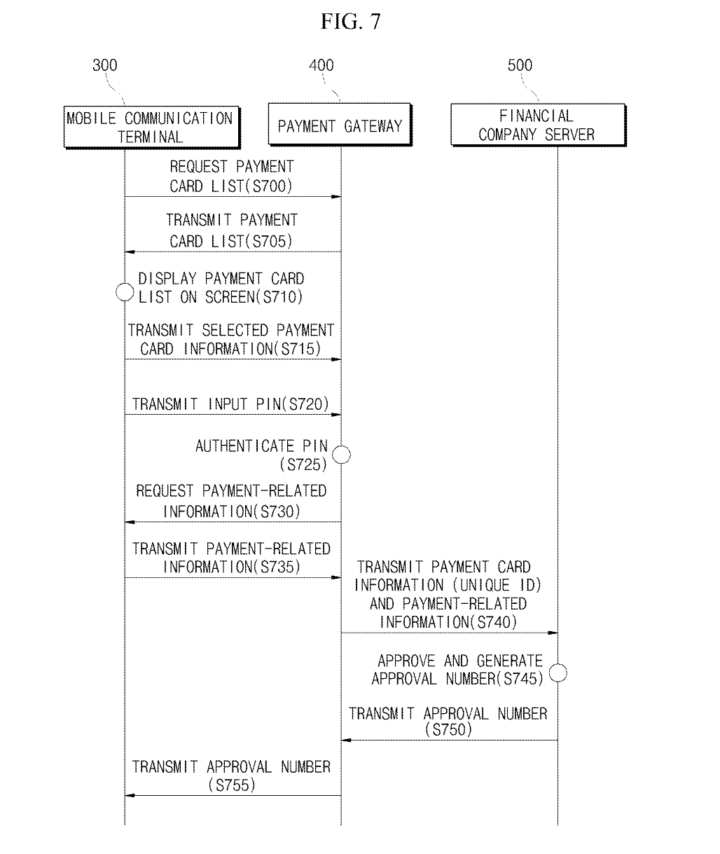

FIG. 7 is a flowchart for a card payment performed between the mobile communication terminal, the payment gateway, and the financial company server according to another embodiment of the present invention.

The mobile communication terminal 300 requests a payment card list from the payment gateway 400 in operation S700. However, such a request operation may not be performed. The payment gateway 400 searches the database to find the payment card list included in payment-related information of a corresponding member according to the payment card list request or even without the request, and then transmits the found payment card list to the mobile communication terminal 300 in operation S705. At this time, the payment gateway 400 may further search for a unique ID given to each payment card of the corresponding member, and transmit both the unique ID and the payment card list to the mobile communication terminal 300. For reference, operations S700 and S705 may be performed before or after operations S530 and S540 of FIG. 5. The mobile communication terminal 300 receives the payment card list from the payment gateway 400, and displays the payment card list on a screen in operation S710. In an embodiment, the payment card list is a list of payment card names of the corresponding member. Therefore, a user can easily select a desired payment card through the screen of the mobile communication terminal 300.

The mobile communication terminal 300 itself may have the payment card list from the payment gateway 400. That is, the memory of the mobile communication terminal 300 stores information including the payment card list. In this case, the mobile communication terminal 300 does not receive the payment card list from the payment gateway 400 but reads the payment card list stored in the memory to display the payment card list. Therefore, when the mobile communication terminal 300 stores the information including the payment card list, it is not required to perform the above-described operations S700 and S705.

After the payment card list is displayed on the screen, when one payment card is selected by the user, the mobile communication terminal 300 requests an input of a PIN of the selected payment card. However, a PIN input procedure may not be performed. That is, when a payment process does not include a PIN authentication procedure, the PIN input procedure may not be performed. Hereinafter, the PIN authentication procedure is assumed as being performed. The mobile communication terminal 300 transmits the payment card information selected by the user to the payment gateway 400 in operation S715. In an embodiment, the payment card information transmitted from the payment gateway 400 is a payment card name or a unique ID given to a corresponding payment card. In addition, when a PIN is inputted, the mobile communication terminal 300 transmits the input PIN to the payment gateway 400 in operation S720. The payment card information and the PIN may be transmitted together, or may be each transmitted. When the PIN is transmitted to the payment gateway 400, the payment gateway 400 compares the received PIN with a PIN of the corresponding payment card registered in the database to effect an authentication in operation S725. When the authentication succeeds, the payment gateway 400 requests payment-related information from the mobile communication terminal 300 in operation S730. Therefore, the mobile communication terminal 300 transmits the payment-related information, received from the relay device 200, to the payment gateway 400 in operation S735. The payment gateway 400 transmits the payment card information and the payment-related information to the financial company server 500 in operation S740. Here, the transmitted payment card information may be a unique ID given to the payment card. For example, when the payment card information received from the mobile communication terminal 300 is a payment card name, the payment gateway 400 searches the database to find a unique ID corresponding to the payment card name of a corresponding member.

In FIG. 7, it is illustrated that the PIN is authenticated, and then the payment-related information is transmitted to the payment gateway 400. However, the payment-related information may be transmitted to the payment gateway 400 before the PIN is authenticated. In this case, the payment-related information and the payment card information may be transmitted together, or may be each transmitted. Further, when the authentication of the PIN fails, the payment gateway 400 may newly request an input of the PIN from the mobile communication terminal 300, or may inform the failure of the card payment of the mobile communication terminal 300 and may not perform an operation subsequent thereto.

The financial company server 500 receives the payment card information and the payment-related information from the payment gateway 400. The financial company server 500 determines whether to approve according to a card payment approval request, by using the database that stores registered payment card information of each card member. Specifically, the financial company server 500 compares the received payment card information and payment-related information with member data or affiliated merchant data of each company to determine whether a transaction between a payment card user and an affiliated merchant is right. At this time, even when the received payment card information includes only information on a unique ID given to a corresponding payment card without including a payment card identification number, the financial company server 500 may validly approve the card transaction because unique ID information of each payment card is previously registered in the database. When the transaction between the payment card user and the affiliated merchant is right, the financial company server 500 generates an approval number for approving the transaction in operation S745, and transmits the generated approval number to the payment gateway 400 in operation S750. The payment gateway 400 receives the approval number from the financial company server 500, and transmits the received approval number to the mobile communication terminal 300 in operation S755. Also, the payment gateway 400 may transmit the approval number to the affiliated merchant terminal 100. Also, the payment gateway 400 may directly transmit the approval number to the relay device 200. To this end, the payment gateway 400 should know the IP address of the relay device 200 for transmitting the approval number to the relay device 200. That is, the relay device 200 transmits the IP address and payment-related information to the mobile communication terminal 300, and the mobile communication terminal 300 transfers the IP address to the payment gateway 400, thereby enabling the payment gateway 400 to know the IP address.

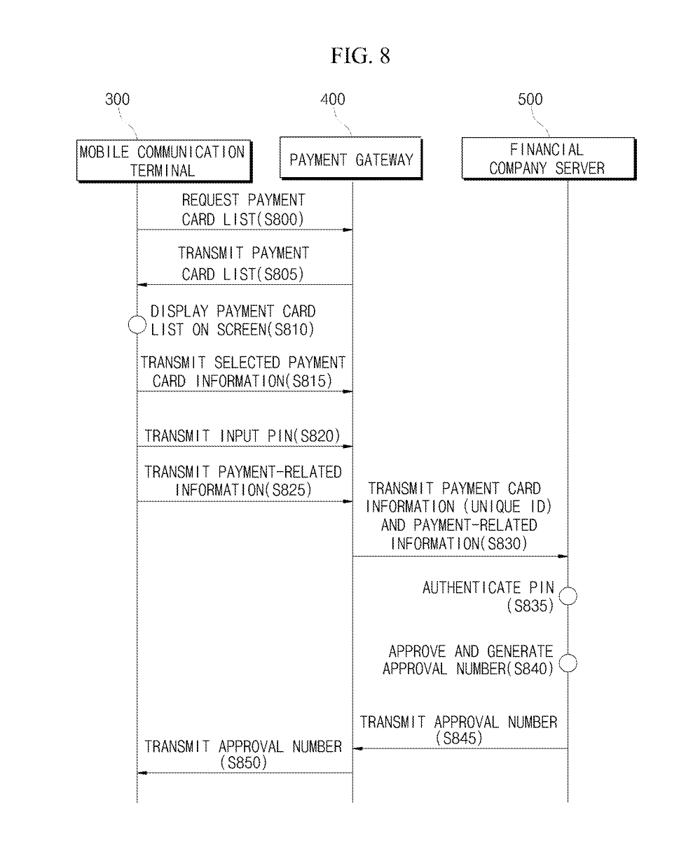

FIG. 8 is a flowchart for a card payment performed between the mobile communication terminal, the payment gateway, and the financial company server according to another embodiment of the present invention.

The mobile communication terminal 300 requests a payment card list from the payment gateway 400 in operation S800. However, such a request operation may not be performed. The payment gateway 400 searches the database to find the payment card list included in payment-related information of a corresponding member according to the payment card list request or even without the request, and then transmits the found payment card list to the mobile communication terminal 300 in operation S805. At this time, the payment gateway 400 may further search for a unique ID given to each payment card of the corresponding member, and transmit both the unique ID and the payment card list to the mobile communication terminal 300. For reference, operations S800 and S805 may be performed before or after operations S530 and S540 of FIG. 5. The mobile communication terminal 300 receives the payment card list from the payment gateway 400, and displays the payment card list on a screen in operation S810. In an embodiment, the payment card list is a list of payment card names of the corresponding member. Therefore, a user can easily select a desired payment card through the screen of the mobile communication terminal 300.

The mobile communication terminal 300 itself may have the payment card list from the payment gateway 400. That is, the memory of the mobile communication terminal 300 stores information including the payment card list. In this case, the mobile communication terminal 300 does not receive the payment card list from the payment gateway 400 but reads the payment card list stored in the memory to display the payment card list. Therefore, when the mobile communication terminal 300 stores the information including the payment card list, it is not required to perform the above-described operations S800 and S805.

After the payment card list is displayed on the screen, when one payment card is selected by the user, the mobile communication terminal 300 requests an input of a PIN of the selected payment card. However, a PIN input procedure may not be performed. That is, when a payment process does not include a PIN authentication procedure, the PIN input procedure may not be performed. Hereinafter, the PIN authentication procedure is assumed as being performed. The mobile communication terminal 300 transmits the payment card information selected by the user to the payment gateway 400 in operation S815. In an embodiment, the payment card information transmitted from the payment gateway 400 is a payment card name or a unique ID given to a corresponding payment card. In addition, when a PIN is inputted, the mobile communication terminal 300 transmits the input PIN to the payment gateway 400 in operation S820. Also, the mobile communication terminal 300 transmits the payment-related information, received from the relay device 200, to the payment gateway 400 in operation S825. The payment card information, the PIN, and the payment-related information may be transmitted together, or may be each transmitted. The payment gateway 400 transmits the payment card information, the PIN, and the payment-related information to the financial company server 500 in operation S830. Here, the transmitted payment card information may be a unique ID given to the payment card. For example, when the payment card information received from the mobile communication terminal 300 is a payment card name, the payment gateway 400 searches the database to find a unique ID corresponding to the payment card name of a corresponding member.

The financial company server 500 receives the payment card information, the PIN, and the payment-related information from the payment gateway 400. The financial company server 500 compares the received PIN with a PIN of the corresponding payment card registered in the database to effect an authentication in operation S835. After the financial company server 500 authenticates the PIN, the payment gateway 400 may transmit the payment-related information to the financial company server 500. That is, when the financial company server 500 authenticates the PIN through operation S835, the financial company server 500 requests the payment-related information from the payment gateway 400, and the payment gateway 400 transmits the payment-related information to the financial company server 500 according to the request.

When the authentication of the PIN is normally made through operation S835, the financial company server 500 determines whether to approve according to a card payment approval request, by using the database that stores registered payment card information of each card member. Specifically, the financial company server 500 compares the received payment card information and payment-related information with member data or affiliated merchant data of each company to determine whether a transaction between a payment card user and an affiliated merchant is right. At this time, even when the received payment card information includes only information on a unique ID given to a corresponding payment card without including a payment card identification number, the financial company server 500 may validly approve the card transaction because unique ID information of each payment card is previously registered in the database. When the transaction between the payment card user and the affiliated merchant is right, the financial company server 500 generates an approval number for approving the transaction in operation S840, and transmits the generated approval number to the payment gateway 400 in operation S845. The payment gateway 400 receives the approval number from the financial company server 500, and transmits the received approval number to the mobile communication terminal 300 in operation S850. Also, the payment gateway 400 may transmit the approval number to the affiliated merchant terminal 100. Also, the payment gateway 400 may directly transmit the approval number to the relay device 200. To this end, the payment gateway 400 should know the IP address of the relay device 200 for transmitting the approval number to the relay device 200. That is, the relay device 200 transmits the IP address and payment-related information to the mobile communication terminal 300, and the mobile communication terminal 300 transfers the IP address to the payment gateway 400, thereby enabling the payment gateway 400 to know the IP address.

In the above-described embodiments, it has been described that the mobile communication terminal 300 performs the payment process in interoperation with the payment gateway 400, but the mobile communication terminal 300 may perform the payment process in direct interoperation with the financial company server 500. That is, the financial company server 500 directly performs a function of the payment gateway 400, to which end the payment gateway 400 is not provided in FIG. 1 and the mobile communication terminal 300 is directly communication-connected to the financial company server 500 over a wireless network.

When an affiliated merchant terminal transfers payment-related information through a dongle, a payment request statement from the affiliated merchant terminal to the dongle (for example, an NFC reader) is as shown in Table 1, and a response statement to a payment request statement from the NFC reader to the affiliated merchant terminal is as shown in Table 2.

TABLE 1

| Seq | Field Name | Length | Type | Description | Basic Value |
|---|---|---|---|---|---|
| 1 | STX | 1 | Hex | Message Start | 0x02 |
| 2 | Seq No | 1 | Hex | Consecutive | 0x00 (Not Use.) |
| | | | | Numbers | |
| 3 | Sender Index | 2 | Hex | Transmitter | 0x0B 0x01 |
| | | | | Index | |
| 4 | Receiver | 2 | Hex | Receiver | 0x0E 0x01 |
| | Index | | | Index | |
| 5 | Command | 1 | Hex | Command | See Command |
| | Code | | | Code | Code |
| 6 | Data Length | 2 | Hex | Data Length | Use Big Endian |
| 7 | Request | Var | | Requested | |
| | Data | | | Data | |
| 8 | CRC | 2 | Hex | Not Use. | 0x0000 |
| 9 | ETX | 1 | Hex | Message End | 0x03 |

The payment-related information including an affiliated merchant ID and a payment amount is added into a request data field, and transferred to the NFC reader.

TABLE 2

| Seq | Field Name | Length | Type | Description | Basic Value |
|---|---|---|---|---|---|
| 1 | STX | 1 | Hex | Message Start | 0x02 |
| 2 | Seq No | 1 | Hex | Consecutive | SeqNo + 0x01 |
| | | | | Numbers | of Request |
| | | | | | Statement |
| 3 | Sender Index | 2 | Hex | Transmitter | 0x0E 0x01 |
| | | | | Index | |
| 4 | Receiver | 2 | Hex | Receiver | 0x0B 0x01 |
| | Index | | | Index | |
| 5 | Command | 1 | Hex | Command | See Command |
| | Code | | | Code | Code |
| 6 | Data Length | 2 | Hex | Data Length | Use Big Endian |
| | | | | | (Including |
| | | | | | Length of |
| | | | | | Response Code) |
| 7 | Response | 1 | Hex | Response | See Response |
| | Code | | | Code | Code |
| 8 | Response | Var | | Response | |
| | Data | | | Data | |
| 9 | CRC | 2 | Hex | Not Use. | |
| 10 | ETX | 1 | Hex | Message End | 0x03 |

When the NFC reader normally receives the payment-related information included in the request data field of the payment request statement, the NFC reader generates a response statement which is composed as shown in Table 2, and transmits the response statement to the affiliated merchant terminal. A response data field of the response statement includes information that indicates the payment-related information being normally received. Subsequently, a data field structure for transferring the payment-related information from the NFC reader to a relay device may be based on an NFC interface spec.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A card payment system comprising:
an affiliated merchant terminal configured to transmit payment-related information comprising an affiliated merchant ID and a payment amount; and
a relay device configured to store the payment-related information transmitted from the affiliated merchant terminal in a memory, and provide the payment-related information stored in the memory to a mobile communication terminal of a customer, for a card payment using the mobile communication terminal of the customer.

2. The card payment system of claim 1, wherein the relay device is fixed to a table.

3. The card payment system of claim 1, wherein when the relay device receives card payment approval information from the affiliated merchant terminal or the mobile communication terminal, the relay device prints a sales check that comprises the payment-related information and the card payment approval information.

4. A relay device for a card payment using a mobile communication terminal, the relay device comprising:
a communicator configured to transmit or receive data;
a storage configured to store data; and
a controller configured to transmit payment-related information to a mobile communication terminal of a customer through the communicator, for performing a card payment using the mobile communication terminal.

5. The relay device of claim 4, wherein the payment-related information to be transmitted to the mobile communication terminal is received from an affiliated merchant terminal through the communicator.

6. The relay device of claim 4, further comprising a printer configured to print a sales check,
wherein when card payment approval information is received through the communicator, the controller controls the printer to generate sales-check data that comprises the payment-related information and the card payment approval information and print a sales check with the generated sales-check data reflected therein.

7. The relay device of claim 4, wherein the payment-related information comprises information on an affiliated merchant ID and a payment amount.

8. The relay device of claim 4, further comprising a display configured to display information,
wherein the controller outputs the payment-related information to the display for the customer to check the payment-related information.

9. The relay device of claim 4, further comprising an input unit configured to receive a key input,
wherein the controller transmits the payment-related information to the mobile communication terminal through the communicator according to a specific key input received through the input unit.

10. A mobile communication terminal for a card payment, the mobile communication terminal comprising:
a communicator configured to comprise one or more communication units for transmitting or receiving data; and
a controller configured to transmit payment card information and payment-related information to an outside through the communicator for requesting an approval of a card payment, the payment-related information being acquired from a relay device.

11. The mobile communication terminal of claim 10, wherein the payment-related information comprises information on an affiliated merchant ID and a payment amount.

12. The mobile communication terminal of claim 10, wherein the payment card information is a unique ID given to a payment card or a payment card name.

13. The mobile communication terminal of claim 10, wherein the controller transmits the payment card information and the payment-related information to a financial company server or a payment gateway through the communicator.

14. The mobile communication terminal of claim 13, further comprising:
an input unit configured to receive a user input; and
a display configured to display information,
wherein the controller outputs one or more pieces of payment card information of a user of the mobile communication terminal to the display, and transmits one piece of payment card information, selected through the input unit from among the one or more pieces of payment card information displayed by the display, to the financial company server or the payment gateway.

15. The mobile communication terminal of claim 14, wherein the controller receives the one or more pieces of payment card information from the financial company server or the payment gateway, and outputs the one or more pieces of payment card information to the display.

16. A payment gateway for a card payment using a mobile communication terminal, the payment gateway comprising:
a communicator configured to comprise one or more communication units for transmitting or receiving data;
a database configured to store one or more pieces of payment card information of each member; and
a controller configured to, when payment-related information comprising an affiliated merchant ID and a payment amount is received from a mobile communication terminal of a member through the communicator, search the database to check corresponding payment card information, and transmit the checked payment card information and the received payment-related information to a corresponding financial company server through the communicator to request an approval of a card payment.

17. The payment gateway of claim 16, wherein the payment card information transmitted to the financial company server is a unique ID given to a payment card.

18. A payment gateway for a card payment using a mobile communication terminal, the payment gateway comprising:
a communicator configured to comprise one or more communication units for transmitting or receiving data;
a database configured to store one or more pieces of payment card information of each member; and
a controller configured to transmit the one or more pieces of payment card information stored in the database to a mobile communication terminal of a corresponding member through the communicator, and transmit one piece of payment card information received from the mobile communication terminal and payment-related information to a corresponding financial company server through the communicator to request an approval of a card payment, the payment-related information comprising an affiliated merchant ID and a payment amount.

19. The payment gateway of claim 18, wherein,
the payment card information received from the mobile communication terminal through the communicator is a unique ID given to a corresponding payment card or a payment card name, and
the payment card information transmitted to the financial company server is a unique ID given to the corresponding payment card.

20. The payment gateway of claim 18, wherein whenever the a payment program of the mobile communication terminal is executed, the controller transmits the one or more pieces of payment card information to the mobile communication terminal through the communicator.

21. A method of supporting a card payment using a mobile communication terminal in a relay device, the method comprising:
receiving payment-related information, comprising an affiliated merchant ID and a payment amount, from an affiliated merchant terminal;
storing the received payment-related information in a memory;
displaying the payment-related information on a screen; and
transmitting the payment-related information stored in the memory to a mobile communication terminal of a customer, for a card payment using the mobile communication terminal of the customer.

22. The method of claim 21, further comprising:
receiving card payment approval information corresponding to the payment-related information from the affiliated merchant terminal; and
printing a sales check that comprises the payment-related information and the card payment approval information.

23. A method of supporting a card payment using a mobile communication terminal in a relay device, the method comprising:
receiving a payment amount from a user; and
transmitting payment-related information, comprising an affiliated merchant ID and the received payment amount, to a mobile communication terminal of a customer, for a card payment using the mobile communication terminal.

24. The method of claim 23, further comprising receiving the affiliated merchant ID.

25. The method of claim 23, wherein the affiliated merchant ID is previously stored in a memory.

26. A card payment method of a mobile communication terminal, the card payment method comprising:
receiving payment-related information, comprising an affiliated merchant ID and a payment amount, from a relay device;
displaying one or more pieces of payment card information of a user of a mobile communication terminal; and
transmitting one piece of payment card information, selected by the user from among the displayed one or more pieces of payment card information, and the payment-related information to a payment gateway, for requesting an approval of a card payment.

27. The card payment method of claim 26, further comprising receiving the one or more pieces of payment card information of the user from the payment gateway,
wherein the displaying comprises displaying the one or more pieces of payment card information received from the payment gateway.

28. The card payment method of claim 26, further comprising requesting an input of an authentication code of the selected payment card,
wherein the transmitting comprises further transmitting the input authentication code to the payment gateway.

29. The card payment method of claim 26, wherein in the transmitting, the payment card information and the payment-related information are separately transmitted.

30. The card payment method of claim 26, wherein the payment-related information transmitted to the payment gateway is a unique ID given to a payment card or a payment card name.

31. A method of supporting a card payment using a mobile communication terminal in a payment gateway, the method comprising:
receiving payment-related information, comprising an affiliated merchant ID and a payment amount, from a mobile communication terminal of a member which desires a card payment;
when the payment-related information is received, searching a database to find payment card information of the member; and
transmitting the received payment-related information and the found payment card information to a corresponding financial company server to request an approval of a card payment.

32. The method of claim 31, wherein the payment card information transmitted to the financial company server issuing a payment card is a unique ID given to the payment card.

33. A method of supporting a card payment using a mobile communication terminal in a payment gateway, the method comprising:
searching a database to find payment card information of a member which desires a card payment;
transmitting one or more pieces of the found payment card information to a mobile communication terminal of the member;
receiving payment card information, selected by the member from among the one or more pieces of payment card information, and payment-related information from the mobile communication terminal, the payment-related information comprising an affiliated merchant ID and a payment amount; and
transmitting the received payment card information and payment-related information to a corresponding financial company server.

34. The method of claim 33, wherein the selected payment card information and the payment-related information are separately received.

35. The method of claim 33, wherein,
the payment card information transmitted to the mobile communication terminal comprises a payment card list, and
the payment card information transmitted to the financial company server comprises a unique ID given to a corresponding payment card.

36. The method of claim 33, wherein the transmitting to a corresponding financial company server comprises further transmitting an authentication code of the selected payment card, received from the mobile communication terminal, to the financial company server, for an authentication in the financial company server.

37. The method of claim 33, further comprising authenticating an authentication code of the selected payment card received from the mobile communication terminal,
wherein when the authentication succeeds, the payment-related information is received from the mobile communication terminal.

38. The method of claim 33, further comprising authenticating an authentication code of the selected payment card received from the mobile communication terminal,
wherein the transmitting to a corresponding financial company server is performed when the authentication succeeds.
